(19) United States
(12) Patent Application Publication
(10) Pub. No.: US 2021/0072494 A1
(43) Pub. Date: Mar. 11, 2021

(54) LENS MODULE AND ELECTRONIC APPARATUS

(71) Applicant: AAC Optics Solutions Pte. Ltd., Singapore city (SG)

(72) Inventors: Yinlong Zhu, Shenzhen (CN); Gang Li, Shenzhen (CN)

(21) Appl. No.: 16/999,095

(22) Filed: Aug. 21, 2020

(30) Foreign Application Priority Data
Sep. 11, 2019 (CN) 201910860161.0

(51) Int. Cl. G02B 7/09; G03B 13/36; G02B 27/64; H04N 5/232

(52) U.S. Cl. CPC G02B 7/09; H04N 5/23287; G02B 27/64; G03B 13/36

(57) ABSTRACT

A lens module and an electronic apparatus are disclosed. The lens module includes an auto-focusing assembly, an optical image stabilization assembly, an elastic support assembly, and a driving assembly. The auto-focusing assembly includes a pair of first side walls and a pair of second side walls. The driving assembly includes a first binding clip, a second binding clip, and a shape-memory alloy wire disposed between the first binding clip and the second binding clip. Each of the first binding clip and the second binding clip includes a first conductive plate arranged on the optical image stabilization assembly and a second conductive plate bending from the first conductive plate. Each shape-memory alloy wire includes a first tail end, a second tail end, and a driving end. The driving end is cooperatively connected to a junction between the first side wall and the second side wall adjacent to each other.

### TECHNICAL FIELD

The described embodiments relates to the field of optical imaging technology, and more specifically, to a lens module.

### BACKGROUND

In recent years, portable terminals, such as smart phones and tablet computers, are equipped with high-performance lens modules. The high-performance lens modules generally have an auto-focusing (AF) function and an optical image stabilization (OIS) function. An AF assembly is disposed in an OIS component via a plurality of elastic supports, and is driven by a plurality of shape-memory alloy wires to achieve the AF function and the OIS function. During the AF process of the high-performance lens modules, a lens is moved along an optical axis of the lens. When performing the OIS function, the lens is moved along a direction perpendicular to the optical axis of the lens.

In the related art, binding clips configured to fix the shape-memory alloy wire will cause an overall size of the lens module to be too large, which is not suitable for the requirements for miniaturization of lenses in the current market.

Therefore, it is necessary to provide an improved lens module.

### SUMMARY

In some aspects of the present disclosure, a lens module may be disclosed. The lens module may include an auto-focusing assembly, comprising: a pair of first side walls, opposite to each other; and a pair of second side walls, opposite to each other and connected between the pair of first side walls; wherein the pair of first side walls and the pair of second side walls cooperatively form a ring; an optical image stabilization assembly, spaced apart from the auto-focusing assembly in an optical axis of a lens; an elastic support assembly, connected between the auto-focusing assembly and the optical image stabilization assembly; and a driving assembly, configure to drive the optical image stabilization assembly to move in a direction substantially perpendicular to the optical axis, and comprising: a first binding clip, arranged on at an outer side of one of the pair of first side walls; a second binding clip, arranged on at an outer side of one of the pair of second side walls; and a shape-memory alloy wire, disposed between the first binding clip and the second binding clip. Each of the first binding clip and the second binding clip comprises: a first conductive plate, arranged at one side of the optical image stabilization assembly facing towards the auto-focusing assembly; and a second conductive plate, bending from the first conductive plate in a direction toward the auto-focusing assembly. The second conductive plate of the first binding clip is disposed at the outer side of the corresponding one of the pair of first side walls, and the second conductive plate of the second binding clip is disposed at the outer side of the corresponding one of the pair of second side walls, respectively. Each shape-memory alloy wire comprises: a first tail end, connected to the second conductive plate of the first binding clip, a second tail end, connected to the second conductive plate of the second binding clip, and a driving end, connected between the first tail end and the second tail end; wherein the driving end is cooperatively connected to a junction between the first side wall and the second side wall adjacent to each other.

In some embodiments, the second conductive plate is substantially perpendicular to the first conductive plate.

In some embodiments, a plane at which a face of the second conductive plate having the largest area is located is defined as a main plane, and a normal direction of the main plane faces towards the first side wall or the second side wall.

In some embodiments, glue is dispensed between the driving end and the junction between the first side wall and the second side wall, such that the driving end is adhered to the junction between the first side wall and the second side wall.

In some embodiments, the lens module further comprises a mounting post protruding from one side of the optical image stabilization assembly that faces towards the auto-focusing assembly. A mounting hole is defined in the first conductive plate and further extends through the first conductive plate. The mounting post is inserted into the mounting hole.

In some embodiments, the optical image stabilization assembly defines a recess at one side facing towards the auto-focusing assembly, and the recess is configured to receive the first conductive plate. The recess has a bottom surface facing towards the auto-focusing assembly, and the mounting post protrudes from the bottom surface.

In some embodiments, the lens module further comprises: a first step, protruding from an outer side wall at one end of the auto-focusing assembly that is close to the optical image stabilization assembly and located at the junction between the first side wall and the second side wall; and a second step, protruding from the first step in a direction away from the outer side wall of the auto-focusing assembly. The second step is dispose closer to the optical image stabilization assembly than the first step. A thickness of the second step in the direction perpendicular to the optical axis is greater than a thickness of the first step in the direction perpendicular to the optical axis. The driving end is fixed at one side of the first step away from the optical image stabilization assembly.

In some embodiments, the number of the driving assemblies is four, and each of middle portions at the outer sides of the pair of first side walls and middle portions at the outer sides of the pair of second side walls has two binding clips arranged thereon. The driving end of each binding clip is connected to a corresponding one of the junctions between the first side walls and the second side walls.

In some embodiments, the elastic support assembly comprises at least two elastic support components, and each of the at least two elastic support components comprises: a first connecting end, connected to the auto-focusing assembly; a second connecting end, connected to the optical image stabilization assembly; and an elastic support body, connected between the first connecting end and the second connecting end.

In some embodiments, the elastic support body of each of the at least two elastic support components comprises: a first extending portion, having one end connected to the first connecting end; and a second extending portion, having one end connected to the second connecting end. The other end of the first extending portion away from the first connecting end is connected to the other end of the second extending portion away from the second connecting end; both the first extending portion and the second extending portion are substantially perpendicular to the optical axis, and the first extending portion is substantially perpendicular to the second extending portion.

In some embodiments, the auto-focusing assembly comprises: a first base; and a first circuit board, fixed at one side of the first base facing towards the optical image stabilization assembly. The first connecting end is electrically connected to the first circuit board. The optical image stabilization assembly comprises: a second base; and a second circuit board, fixed at one side of the second base away from the auto-focusing assembly, wherein the second connecting end is electrically connected to the second circuit board.

In some embodiments, the second base defines a through hole at a position corresponding to the elastic support body, and the elastic support body passes through the through hole; the second connecting end is welded to the second circuit board.

In some embodiments, the lens module further comprises a cover disposed at one side of the second circuit board away from the second base. The second circuit board comprises: a first electric board, arranged above the second base; and a second electric board, bent from the first electric board in a direction away from the second base. The cover comprises: a first protective plate, attached to the first electric board; and a second protection plate, connected to the first protective plate and attached to the second electric board.

In some embodiments, the lens module further comprises a bottom shell, wherein the bottom shell defines a cavity, and the auto-focusing assembly is partially received in the cavity.

In some embodiments, the number of the elastic support components is four; the first connecting ends of the four elastic support components are distributed along a circumference of the auto-focusing assembly at equal internals, and the second connecting ends of the four elastic support components are distributed along a circumference of the optical image stabilization assembly at equal internals; and each of the first connecting ends is connected to the adjacent second connecting end in a counterclockwise or clockwise direction along the optical axis via the elastic support body.

In some embodiments, the second connecting end extends from the elastic support body in a direction towards the optical axis.

In some aspects, an electronic apparatus may be further disclosure. The electronic apparatus may include a housing and a lens module as previously described.

### BRIEF DESCRIPTION OF THE DRAWINGS

FIG. 1 is a perspective view of a lens module according to some embodiments of the present disclosure.

FIG. 2 is an explosive view of the lens module according to some embodiments of the present disclosure.

FIG. 3 is another explosive view of the lens module according to some embodiments of the present disclosure.

FIG. 4 is a perspective view of a lens module according to some embodiments of the present disclosure.

FIG. 5 is a cross-sectional view along the line A-A in FIG. 4.

FIG. 6 is a partial enlarged view of the portion B shown in FIG. 5.

FIG. 7 is a perspective view of a binding clip according to some embodiments of the present disclosure.

FIG. 8 is a perspective view of a shape-memory alloy wire according to some embodiments of the present disclosure.

FIG. 9 is a perspective view of a second circuit board according to some embodiments of the present disclosure.

FIG. 10 is a perspective view of the lens module with a bottom shell and a cover being removed according to some embodiments of the present disclosure.

FIG. 11 is a partial enlarged view of the portion C shown in FIG. 10.

FIG. 12 is a partial enlarged view of the portion D shown in FIG. 10.

FIG. 13 is a perspective view showing an AF assembly cooperating with an elastic support assembly according to some embodiments of the present disclosure.

FIG. 14 is a perspective view of an elastic support component according to some embodiments of the present disclosure.

FIG. 15 is a bottom view of the AF assembly, an OIS assembly, and a driving assembly.

### LIST OF REFERENCE NUMERALS

10, auto-focusing (AF) assembly; 11, first base; 12, first circuit board; 13, first side wall; 14, second side wall; 15, first step; 16, second step; 17, fixing hole;
20, optical image stabilization (OIS) assembly; 21, second base; 211, through hole; 22, second circuit board; 221, first electrical board; 222, second electrical board; 23, recess; 24, bottom surface of the recess; 25, mounting post; 26, second light-transmitting hole;
30, elastic support assembly; 31, elastic support component; 311, first connecting end; 312, second connecting end; 313, elastic support body; 314, first extending portion; 315, second extending portion; 316, third extending portion; 317, fourth extending portion;
40, driving assembly; 41, shape-memory alloy wire; 411, tail end; 412, driving end; 413, first shape-memory alloy wire; 414, second shape-memory alloy wire; 415, third shape-memory alloy wire; 416, fourth shape-memory alloy wire; 42, binding clip; 421, first conductive plate; 422, second conductive plate; 423, mounting hole; 424, main plane;
50, bottom shell; 51, cavity; 52, first light-transmitting hole;
60, cover; 61, first protective plate; 62, second protective plate; 63, third light-transmitting hole.

### DETAILED DESCRIPTION

The present disclosure will be further described below with reference to the drawings and embodiments.

It should be noted that, all the directional indicator (such as up, down, left, right, front, rear . . . ) in embodiments of the present disclosure are only used for explaining relative positions, the movements, and the like between components in a specific posture (as shown in the drawings). If the specific posture changes, the directional indicators may change accordingly.

It should also be noted that, when an element is referred to as being “fixed on” or “disposed on” another element, the element may be directly disposed on the other element or there may be an intervening element at the same time. When an element is referred to as being “connected” to another element, the element may be directly connected to the other element or an intervening element may be present at the same time.

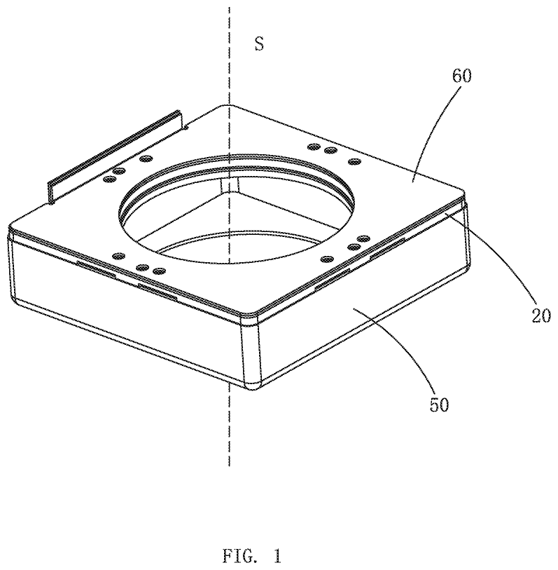

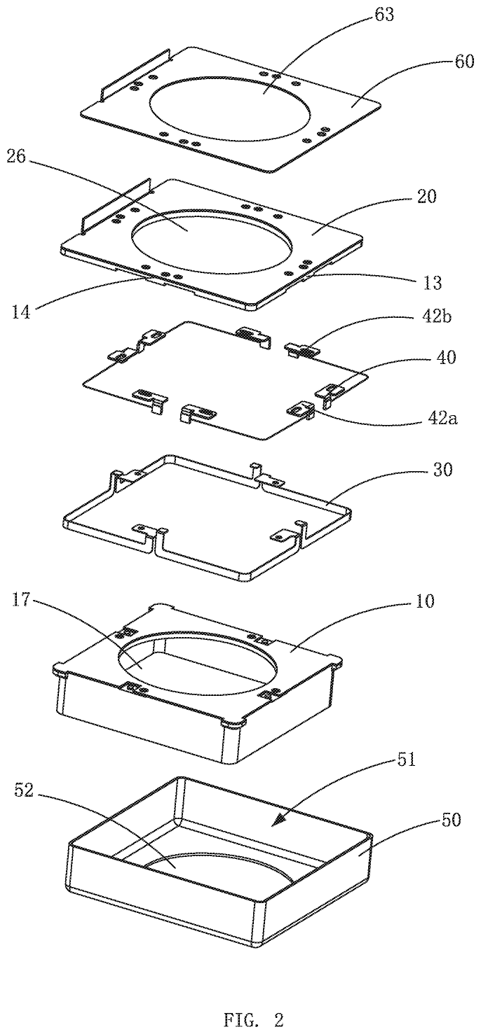

As shown in FIG. 1 to FIG. 2, a lens module may be provided in some embodiments of the present disclosure. The lens module may include an auto-focusing (AF) assembly 10, an optical image stabilization (OIS) assembly 20, an elastic support assembly 30, a driving assembly 40, a bottom shell 50, and a lens disposed on the bottom shell 50. The OIS assembly 20 may be spaced apart from the AF assembly 10 in a direction of an optical axis S of the lens. The bottom shell 50 may be arranged at one side of the AF assembly 10 away from or opposite to the OIS assembly 20. The bottom shell 50 may have a cavity 51. The AF assembly 10 may be partially received or mounted in the cavity 51. The elastic support assembly 30 may be connected between the AF assembly 10 and the OIS assembly 20. The driving assembly 40 may be configured to drive the OIS assembly 20 to move in a direction perpendicular to the optical axis S.

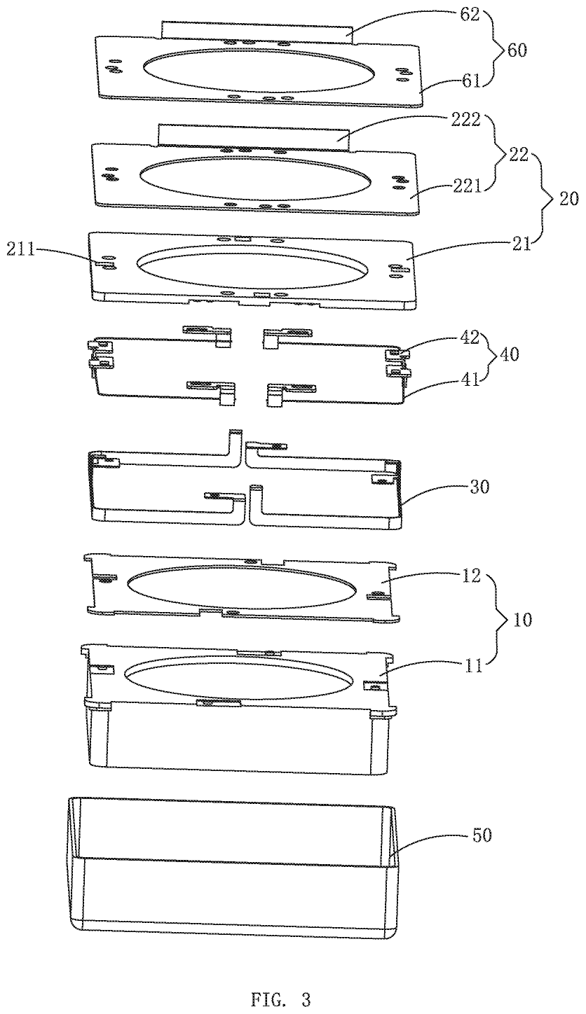

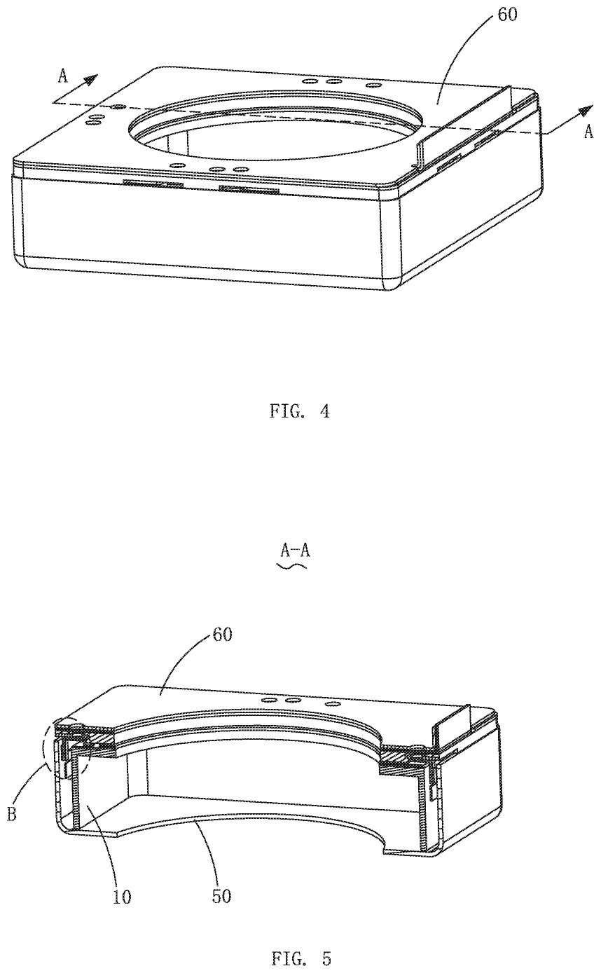

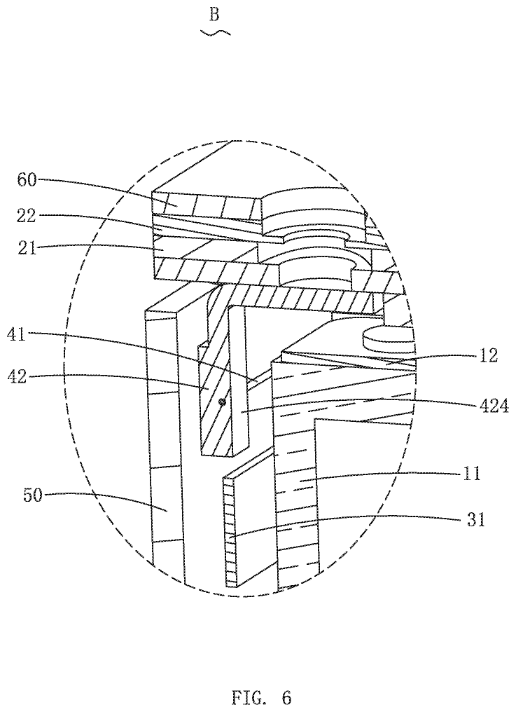

As shown in FIG. 1 to FIG. 6, the AF assembly 10 may include a first base 11 and a first circuit board 12. The first circuit board 12 may be fixed at one side of the first base 11 facing toward or adjacent to the OIS assembly 20. The OIS assembly 20 may include a second base 21 and a second circuit board 22. The second circuit board 22 may be fixed at one side of the second base 21 facing away from the AF assembly 10. The elastic support assembly 30 may include at least two elastic support components 31. Each elastic support component 31 may include a first connecting end 311, a second connecting end 312, and an elastic support body 313 connected between the first connecting end 311 and the second connecting end 312. The first connecting end 311 may be electrically connected to the first circuit board 12 of the AF assembly 10. The second connecting end 312 may be electrically connected to the second circuit board 22 of the OIS assembly 20. The elastic support components 31 may not only support the AF assembly 10, but also have the function of electrically connecting the first circuit board 12 and the second circuit board 22.

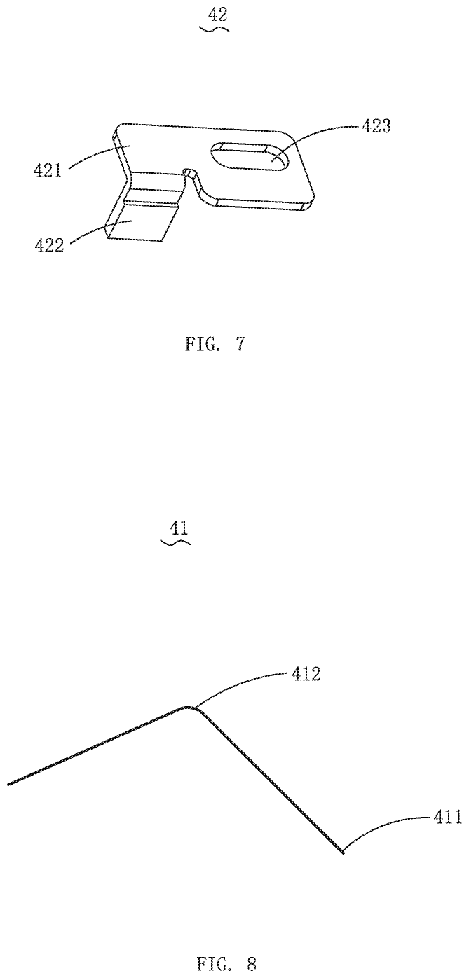

Furthermore, as shown in FIGS. 2 and 7, the AF assembly 10 may include a pair of first side walls 13 and a pair of second side walls 14. The pair of first side walls 13 may be disposed opposite to each other. The pair of second side walls 14 may be connected between the pair of first side walls 13 and may be further disposed opposite to each other. The pair of first side walls 13 and the pair of second side walls 14 cooperatively define or form a ring. The driving assembly 40 may include a first binding clip 42a, a second binding clip 42b, and a shape-memory alloy wire 41. The first binding clip 42a may be arranged at an outer side of one of the first side walls 13, and the second binding clip 42b may be arranged at an outer side of one of the second side walls 14, respectively. The shape-memory alloy wire 41 may be arranged between the first binding clip 42a and the second binding clip 42b. As shown in FIG. 7, each of the first binding clip 42a and the second binding clip 42b may include a first conductive plate 421 and a second conductive plate 422. The first conductive plate 421 may be arranged at one side of the OIS assembly 20 facing towards the AF assembly 10 (that is, a bottom of the second circuit board 22). The second conductive plate 422 may be bent and extended from the first conductive plate 421 in a direction toward the AF assembly 10. The second conductive plate 422 of the first binding clip 42a may be arranged at the outer side of the first side wall 13, and the second conductive plate 422 of the second binding clip 42b may be arranged at the outer side of the second side wall 14 adjacent to the first side wall 13, respectively. The second conductive plate 422 of each of the first binding clip 42a and the second binding clip 42b may be arranged perpendicular to the first conductive plate 421 of each of the first binding clip 42a and the second binding clip 42b. In this way, after assembly, a horizontal size (that is, the size in the direction perpendicular to the optical axis S) of the lens module may be reduced.

According to some embodiments, a plane at which a face of the second conductive plate 422 having the largest area is located may be defined as a main plane 424. A normal direction of the main plane 424 (that is, the direction substantially perpendicular to the main plane 424) may be arranged or face toward the first side wall 13 or toward the second side wall 14. In this way, it is possible to ensure that this configuration may further reduce the size of the lens module in the horizontal direction.

As further shown in FIG. 8, the first binding clip 42a and the second binding clip 42b may be electrically connected to the second circuit board 22. The shape-memory alloy wire 41 may include two tail ends 411 and a driving end 412. The two tail ends 411 may be connected to the second conductive plates 422 of the first binding clip 42a and the second binding clip 42b adjacent to each other, respectively. The driving end 412 may be disposed between the two tail ends 411. The driving end 412 may be cooperatively connected to a junction of the first side wall 13 and the second side wall 14 adjacent to each other, that is, a corner between the first side wall 13 and the second side wall 14 adjacent to each other. A corner of the AF assembly 10 may be configured as a force point, and may be configured to support and fix the shape-memory alloy wire 41, as shown in FIG. 10. A temperature of the shape-memory alloy wire 41 may rise up when the shape-memory alloy wire 41 is energized. Herein, a second shape-memory alloy wire 414 of the shape-memory alloy wire 41 may be taken as an example. The shape-memory alloy wire 41 may shrink and pulling forces F (+Y), F (−X) may be generated. A resultant force may provide a driving force to the force F in a direction at an angle of 45 degrees with respect to +X/−Y axis.

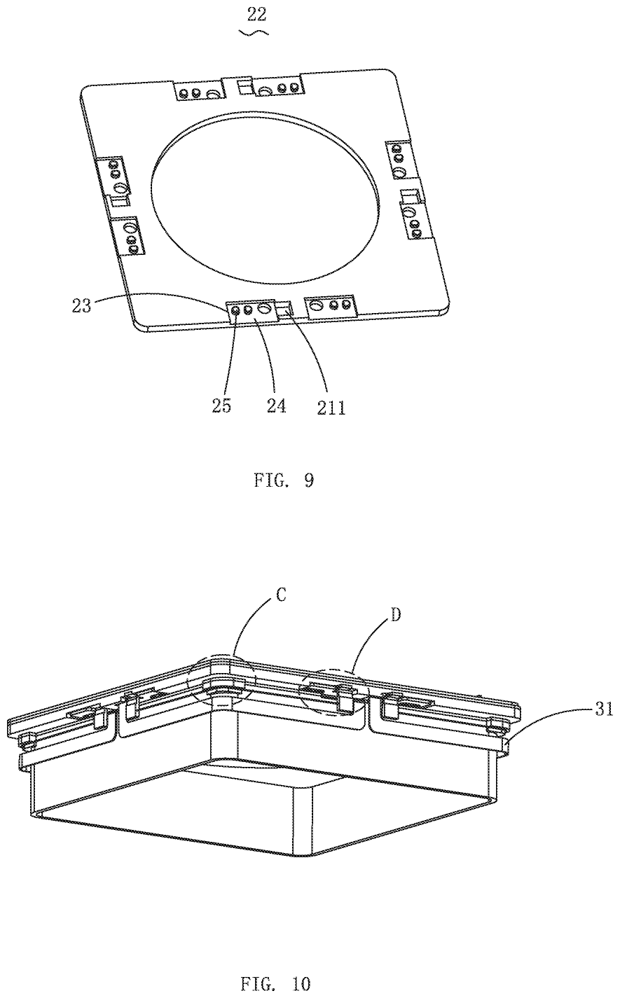

As further shown in FIG. 9, according to some embodiments, the OIS assembly 20 may define a recess 23. The recess 23 may be formed by recessing from one side of the OIS assembly 20 in a direction facing towards the AF assembly 10, and configured to receive the first conductive plate 421. The recess 23 may have a bottom surface 24 facing the AF assembly 10. A mounting post 25 may protrude from the bottom surface 24. The mounting post 25 may include two convex posts spaced apart from each other. A mounting hole 423 may run or extend through the first conductive plate 421. The mounting post 25 may be inserted into the mounting hole 423. In this way, a size of the lens module along the optical axis S direction may be reduced, and a size of the lens module along the direction perpendicular to the optical axis S direction may also be reduced. By the matching or cooperation of the mounting post 25 and the mounting hole 423, it is possible to enhance stability of the fixing of the first binding clip 42a and the second binding clip 42b on the OIS assembly 20.

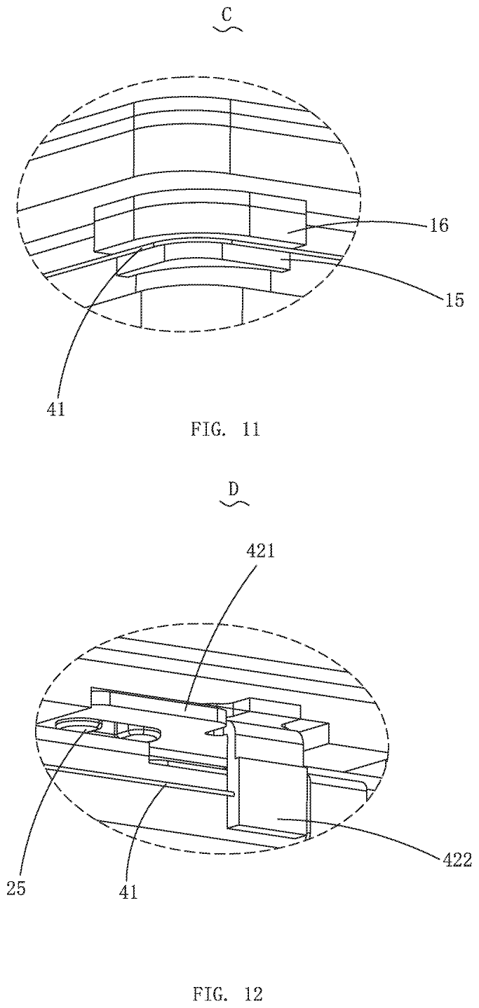

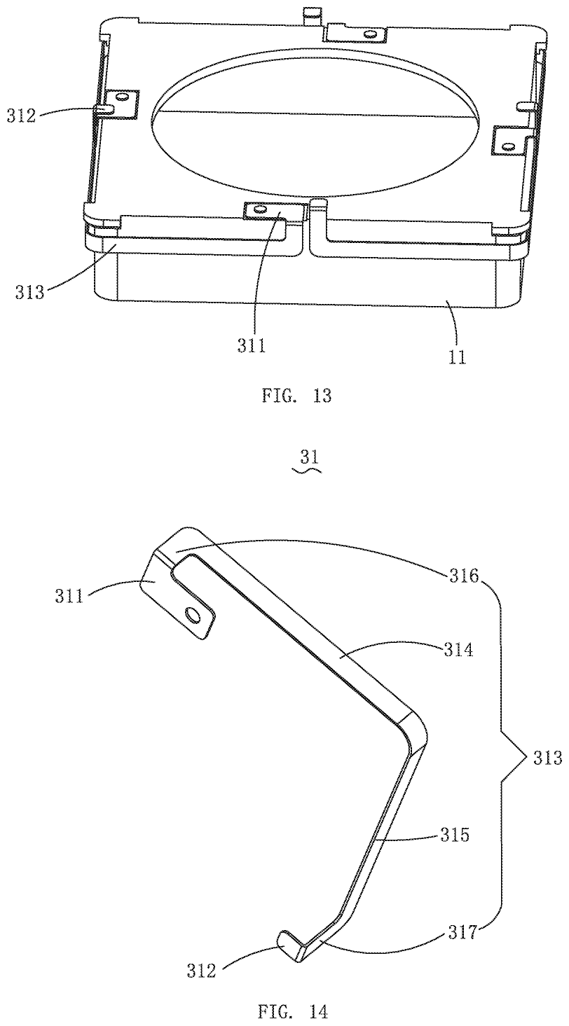

As further shown in FIGS. 10-13, a fixed end of the binding clip 42 may be disposed directly above the AF assembly 10. In this way, it is possible to reduce the possibility of additional increase in the size of the lens module along the direction perpendicular to the optical axis S, and the size of the lens module along the direction perpendicular to the optical axis S may be reduced.

According to some embodiments, a first step or protrusion 15 and a second step or protrusion 16 may be formed on the AF assembly 10. The first step 15 may protrude from the outer side wall at one end of the AF assembly 10 that is close to the OIS assembly 20, and the first step 15 may be further located at the corner of the AF assembly 10. The second step 16 may be arranged in steps with respect to the first step 15, that is, the second step 16 may further protrude from the first step 15 in a direction away from the outer wall of the AF assembly 10. In some embodiments, the second step 16 may be dispose closer to the OIS assembly 20 than the first step 15. A thickness of the second step 16 in the direction perpendicular to the optical axis S may be greater than a thickness of the first step 15 in the direction perpendicular to the optical axis S. The driving end 412 may be fixed at one side of the first step 15 away from the OIS assembly 20 by means of such as glue dispensing. In some embodiments, the glue dispensing may simplify the assembly process between the shape-memory alloy wire 41 and the AF assembly 10 and reduce the manufacturing cost of the lens module. A junction between the second step 16 and the first step 15 may be configured as the force point mentioned above. One side of the first step 15 facing the driving end 412 may have an arc structure, in order to reduce the wear between the shape-memory alloy wire 41 and the first step 15.

In some embodiments, four driving assemblies 40 may be provided. That is, the number of first binding clips 42a and the second binding clips 42b may be four, and the number of the shape-memory alloy wires 41 may also be four. Each of middle portions at the outer sides of the first side wall 13 may have two first binding clips 42a arranged thereon, and each of middle portions at the outer sides of the second side wall 14 may have two second binding clips 42b arranged thereon. Each driving end 412 may be connected to one of the junctions between the first side wall 13 and the second side wall 14 adjacent to each other. The shape-memory alloy wires 41 may be distributed along a circumference of the AF assembly 10 at equal intervals. Correspondingly, the first binding clip 42a and the second binding clip 42b connected to the same shape-memory alloy wire 41 in each group may be distributed at equal intervals along the circumference of the OIS assembly 20.

When the shape-memory alloy wire 41 is energized, the temperature of the shape-memory alloy wire 41 may rise up, the shape-memory alloy wire 41 may shrink, and a driving force at an angle of 45 degrees from the first side wall 13 and the second side wall 14 corresponding to the shape-memory alloy wire 41 which is energized may be generated. In this way, the AF assembly 10 may be moved along the direction perpendicular to the optical axis S, to achieve the OIS function. By providing four shape-memory alloy wires 41 distributed along the circumference of the AF assembly 10 at equal intervals, the AF assembly 10 may be moved in four directions.

More specifically, a through hole 211 may be defined in the second base 21 at a position corresponding to the elastic support body 313. The elastic support body 313 may pass or run through the through hole 211, and the second connecting end 312 may be welded to the second circuit board 22. Welding the second connecting end 312 to the second circuit board 22 may ensure the electrical connection between the elastic support component 313 and the OIS assembly 20. Besides, it is further possible to ensure the stability of the connection between the elastic support component 313 and the OIS assembly 20, and in turn ensure the stability of the indirect connection between the AF assembly 10 and the OIS assembly 20. In some embodiments, the second connecting end 312 may extend from the elastic support body 313 in a direction close to or towards the optical axis S. In this way, it is possible to reduce the possibility of additional increase in the size of the lens module along the direction perpendicular to the optical axis S, and the size of the lens module along the direction perpendicular to the optical axis S may be reduced.

In some embodiments of the present disclosure, the elastic support component 31 may be made of SUS304H, which may have good corrosion resistance and welding performance. The material of this type has a rigidity which may fully ensure the structural stability between the AF assembly 10 and the OIS assembly 20, and may have a certain degree of flexibility. Thus, it is possible to reduce the risk of being broken.

The elastic support body 313 may be arranged on the outer side of the AF assembly 10. The elastic support body 313 may include a first extending portion 314, a second extending portion 315, a third extending portion 316, and a fourth extending portion 317. The first extending portion 314 and the second extending portion 315 may be arranged substantially perpendicular to the optical axis S. The first extending portion 314 may be substantially perpendicular to the second extending portion 315. The third extending portion 316 and the fourth extending portion 317 may be both arranged substantially parallel to the optical axis S. One end of the third extending portion 316 may be connected to the first connecting end 311, and the other end of the third extending portion 316 may be connected to the first extending portion 314. One end of the fourth extending portion 317 may be connected to the second connecting end 312, and the other end of the fourth extending portion 317 may be connected to the second extending portion 315. One end of the first extending portion 314 away from the first connecting end 311 may be connected to one end of the second extending portion 315 away from the second connecting end 312. This connection method may have a simple structure and may simultaneously reduce the size of the lens module along the optical axis S.

In some embodiments, the number of the elastic support components 31 is four. The first connecting ends 311 of the four elastic support components 31 may be distributed along the circumference of the AF assembly 10 at equal intervals, and the second connecting ends 312 of the four elastic support components 31 may be distributed along the circumference of the OIS assembly 20 at equal intervals. Each first connecting end 311 may be connected to the adjacent second connecting end 312 in a counterclockwise or clockwise direction along the optical axis S via the elastic support body 313.

In some embodiments, a position of each elastic support body 313 may correspond to a position of each shape-memory alloy wire 41. After one of the shape-memory alloy wires 41 is completely shrunken to achieve the OIS function, the corresponding elastic support body 313 may move the AF assembly 10 back to the original position according to its own characteristics, that is, generate a restoring force to the AF assembly 10.

In some embodiments, a first light-transmitting hole 52 may be defined in the middle of the bottom shell 50. A fixing hole 17 configured to receive the lens may be defined in the AF assembly 10. A second light-transmitting hole 26 through which lights transmit may be defined in the OIS assembly 20. The first light-transmitting hole 52, the fixing hole 17, and the second light-transmitting hole 26 may be all arranged along the optical axis S. That is to say, an axis of the first light-transmitting hole 52, an axis of the fixing hole 17, and an axis of the second light-transmitting hole 26 may be all coincident with the optical axis S.

The lens module may further include a cover 60 disposed at one side of the second circuit board 22 away from the second base 21. The second circuit board 22 may include a first electrical board 221 and a second electrical board 222. The first electrical board 221 may be mounted on and above the second base 21. The second electrical board 222 may be bent from the first electrical board 221 in a direction away from the second base 21. The cover 60 may include a first protective plate 61 and a second protective plate 62 connected to the first protective plate 61. The first protective plate 61 may be attached to the first electrical board 221, and the second protective plate 62 may be attached to the second electrical board 222. The cover 60 may protect the second circuit board 22 and facilitate the bending of pins on the second circuit board 22. The cover 60 may further define a third light-transmitting hole 63 cooperating or matching with the light-transmitting hole 26. An axis of the third light-transmitting hole 63 may also be coincident with the optical axis S.

According to some embodiments of the present disclosure, the movement of the lens module in a plane perpendicular to the optical axis S of the lens may be as follows.

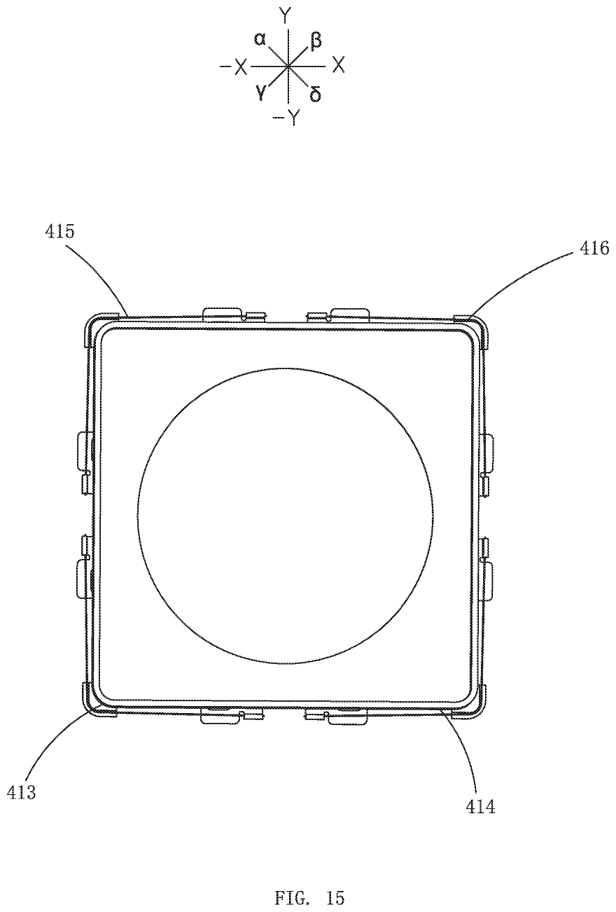

For convenience of description, in FIG. 15, four shape-memory alloy wires 41 may be indicated or referred as follow: a first shape-memory alloy wire 413, a second shape-memory alloy wire 414, a third shape-memory alloy wire 415, and a fourth shape-memory alloy wire 416. In this case, a direction may be a direction at an angle of 45 degrees from the plane where −X and Y are located. β direction may be a direction at an angle of 45 degrees from the plane where X and Y are located. δ direction may be a direction at an angle of 45 degrees from the plane where X and −Y are located. γ direction may be a direction at an angle of 45 degrees from the plane where −X and −Y are located.

As shown in FIG. 15, when the AF assembly 10 needs to move toward the α direction, it is only needs to energize the second shape-memory alloy wire 414 to make the second shape-memory alloy wire 414 to shrink; in this way, the second shape-memory alloy wire 414 may produce a force toward the a direction, thereby driving the AF assembly 10 to move in the α direction. Similarly, when the AF assembly 10 needs to move toward the β direction, it is only needs to energize the first shape-memory alloy wire 413 to make the first shape-memory alloy wire 413 to shrink; in this way, the first shape-memory alloy wire 413 may produce a force toward the β direction, thereby driving the AF assembly 10 to move in the β direction. The principles of the movements of the AF assembly 10 toward the γ and δ directions may be similar to those described above, and will not be repeated here. When the AF assembly 10 is in shape of a square, the α/β/γ/δ direction may be coincident with diagonal directions of the square.

In some embodiments of the present disclosure, since the second conductive plate is bent from the first second conductive plate, it is possible to reduce the size of the lens module along the horizontal direction (the direction substantially perpendicular to the optical axis). Besides, the first tail end and the second tail end are respectively connected to two adjacent second conductive plates, and the driving end is fixed to a junction between the first side wall and the second side wall in the auto-focusing assembly. The junction between the first side wall and the second side wall may be used as the force point, and configured to support and fix the shape-memory alloy wire.

The above are only some embodiments of the present disclosure. It should be pointed out here that for those skilled in the art, improvements may be made without departing from the inventive concept of the present disclosure. All these belong to the protection scope of the present disclosure.

What is claimed is:

1. A lens module, comprising:
an auto-focusing assembly, comprising:
a pair of first side walls, opposite to each other; and
a pair of second side walls, opposite to each other and connected between the pair of first side walls; wherein the pair of first side walls and the pair of second side walls cooperatively form a ring;
an optical image stabilization assembly, spaced apart from the auto-focusing assembly in an optical axis of a lens;
an elastic support assembly, connected between the auto-focusing assembly and the optical image stabilization assembly; and
a driving assembly, configure to drive the optical image stabilization assembly to move in a direction substantially perpendicular to the optical axis, and comprising:
a first binding clip, arranged on at an outer side of one of the pair of first side walls;
a second binding clip, arranged on at an outer side of one of the pair of second side walls; and
a shape-memory alloy wire, disposed between the first binding clip and the second binding clip;
wherein each of the first binding clip and the second binding clip comprises:
a first conductive plate, arranged at one side of the optical image stabilization assembly facing towards the auto-focusing assembly; and
a second conductive plate, bending from the first conductive plate in a direction toward the auto-focusing assembly;
wherein the second conductive plate of the first binding clip is disposed at the outer side of the corresponding one of the pair of first side walls, and the second conductive plate of the second binding clip is disposed at the outer side of the corresponding one of the pair of second side walls, respectively;
wherein each shape-memory alloy wire comprises:
a first tail end, connected to the second conductive plate of the first binding clip,
a second tail end, connected to the second conductive plate of the second binding clip, and
a driving end, connected between the first tail end and the second tail end; wherein the driving end is cooperatively connected to a junction between the first side wall and the second side wall adjacent to each other.

2. The lens module as claimed in claim 1, wherein the second conductive plate is substantially perpendicular to the first conductive plate.

3. The lens module as claimed in claim 1, wherein a plane at which a face of the second conductive plate having the largest area is located is defined as a main plane, and a normal direction of the main plane faces towards the first side wall or the second side wall.

4. The lens module as claimed in claim 1, wherein glue is dispensed between the driving end and the junction between the first side wall and the second side wall, such that the driving end is adhered to the junction between the first side wall and the second side wall.

5. The lens module as claimed in claim 1, further comprising a mounting post protruding from one side of the optical image stabilization assembly that faces towards the auto-focusing assembly;
wherein a mounting hole is defined in the first conductive plate and further extends through the first conductive plate; and
the mounting post is inserted into the mounting hole.

6. The lens module as claimed in claim 5, wherein the optical image stabilization assembly defines a recess at one side facing towards the auto-focusing assembly, and the recess is configured to receive the first conductive plate;
the recess has a bottom surface facing towards the auto-focusing assembly, and the mounting post protrudes from the bottom surface.

7. The lens module as claimed in claim 1, further comprising:
a first step, protruding from an outer side wall at one end of the auto-focusing assembly that is close to the optical image stabilization assembly and located at the junction between the first side wall and the second side wall; and
a second step, protruding from the first step in a direction away from the outer side wall of the auto-focusing assembly;
wherein the second step is dispose closer to the optical image stabilization assembly than the first step;
a thickness of the second step in the direction perpendicular to the optical axis is greater than a thickness of the first step in the direction perpendicular to the optical axis; and
the driving end is fixed at one side of the first step away from the optical image stabilization assembly.

8. The lens module as claimed in claim 1, wherein the number of the driving assemblies is four, and each of middle portions at the outer sides of the pair of first side walls and middle portions at the outer sides of the pair of second side walls has two binding clips arranged thereon;
the driving end of each binding clip is connected to a corresponding one of the junctions between the first side walls and the second side walls.

9. The lens module as claimed in claim 1, wherein the elastic support assembly comprises at least two elastic support components, and each of the at least two elastic support components comprises:
a first connecting end, connected to the auto-focusing assembly;
a second connecting end, connected to the optical image stabilization assembly; and
an elastic support body, connected between the first connecting end and the second connecting end.

10. The lens module as claimed in claim 9, wherein the elastic support body of each of the at least two elastic support components comprises:
a first extending portion, having one end connected to the first connecting end; and
a second extending portion, having one end connected to the second connecting end;
wherein the other end of the first extending portion away from the first connecting end is connected to the other end of the second extending portion away from the second connecting end; both the first extending portion and the second extending portion are substantially perpendicular to the optical axis, and the first extending portion is substantially perpendicular to the second extending portion.

11. The lens module as claimed in claim 10, wherein
the auto-focusing assembly comprises:
a first base; and
a first circuit board, fixed at one side of the first base facing towards the optical image stabilization assembly; wherein the first connecting end is electrically connected to the first circuit board;
wherein the optical image stabilization assembly comprises:
a second base; and
a second circuit board, fixed at one side of the second base away from the auto-focusing assembly, wherein the second connecting end is electrically connected to the second circuit board.

12. The lens module as claimed in claim 11, wherein the second base defines a through hole at a position corresponding to the elastic support body, and the elastic support body passes through the through hole;
the second connecting end is welded to the second circuit board.

13. The lens module as claimed in claim 11, further comprising a cover disposed at one side of the second circuit board away from the second base;
wherein the second circuit board comprises:
a first electric board, arranged above the second base; and
a second electric board, bent from the first electric board in a direction away from the second base;
wherein the cover comprises:
a first protective plate, attached to the first electric board; and
a second protection plate, connected to the first protective plate and attached to the second electric board.

14. The lens module as claimed in claim 11, further comprising a bottom shell, wherein the bottom shell defines a cavity, and the auto-focusing assembly is partially received in the cavity.

15. The lens module as claimed in claim 10, wherein the number of the elastic support components is four;
the first connecting ends of the four elastic support components are distributed along a circumference of the auto-focusing assembly at equal internals, and the second connecting ends of the four elastic support components are distributed along a circumference of the optical image stabilization assembly at equal internals; and
each of the first connecting ends is connected to the adjacent second connecting end in a counterclockwise or clockwise direction along the optical axis via the elastic support body.

16. The lens module as claimed in claim 9, wherein the second connecting end extends from the elastic support body in a direction towards the optical axis.

17. An electronic apparatus, comprising:
a housing; and
a lens module, disposed in the housing and comprising:
an auto-focusing assembly, comprising:
a pair of first side walls, opposite to each other; and
a pair of second side walls, opposite to each other and connected between the pair of first side walls;
an optical image stabilization assembly, spaced apart from the auto-focusing assembly in an optical axis of a lens;
an elastic support assembly, connected between the auto-focusing assembly and the optical image stabilization assembly; and
a driving assembly, configure to drive the optical image stabilization assembly to move in a direction substantially perpendicular to the optical axis, and comprising:
a first binding clip, arranged on at an outer side of one of the pair of first side walls;
a second binding clip, arranged on at an outer side of one of the pair of second side walls; and
a shape-memory alloy wire, disposed between the first binding clip and the second binding clip;
wherein each of the first binding clip and the second binding clip comprises:
a first conductive plate, arranged at one side of the optical image stabilization assembly facing towards the auto-focusing assembly; and
a second conductive plate, bending from the first conductive plate in a direction toward the auto-focusing assembly;
wherein the second conductive plate of the first binding clip is disposed at the outer side of the corresponding one of the pair of first side walls, and the second conductive plate of the second binding clip is disposed at the outer side of the corresponding one of the pair of second side walls, respectively;
wherein each shape-memory alloy wire comprises:
a first tail end, connected to the second conductive plate of the first binding clip,
a second tail end, connected to the second conductive plate of the second binding clip, and
a driving end, connected between the first tail end and the second tail end; wherein the driving end is cooperatively connected to a junction between the first side wall and the second side wall adjacent to each other.

18. The electronic apparatus as claimed in claim 17, wherein the second conductive plate is substantially perpendicular to the first conductive plat; and
a plane at which a face of the second conductive plate having the largest area is located is defined as a main plane, and a normal direction of the main plane faces towards the first side wall or the second side wall.

19. The electronic apparatus as claimed in claim 17, further comprising:
a first step, protruding from an outer side wall at one end of the auto-focusing assembly that is close to the optical image stabilization assembly and located at the junction between the first side wall and the second side wall; and
a second step, protruding from the first step in a direction away from the outer side wall of the auto-focusing assembly;
wherein the second step is dispose closer to the optical image stabilization assembly than the first step;
a thickness of the second step in the direction perpendicular to the optical axis is greater than a thickness of the first step in the direction perpendicular to the optical axis; and
the driving end is fixed at one side of the first step away from the optical image stabilization assembly.

20. The electronic apparatus as claimed in claim 17, wherein the elastic support assembly comprises at least two elastic support components, and each of the at least two elastic support components comprises:
a first connecting end, connected to the auto-focusing assembly;
a second connecting end, connected to the optical image stabilization assembly; and
an elastic support body, connected between the first connecting end and the second connecting end.
